(19) United States
(12) Patent Application Publication
(10) Pub. No.: US 2025/0245914 A1
(43) Pub. Date: Jul. 31, 2025

(54) IMAGE DISPLAY METHOD AND APPARATUS, DEVICE, AND STORAGE MEDIUM

(71) Applicant: Beijing Zitiao Network Technology Co., Ltd., Haidian District (CN)

(72) Inventors: Zeming LI, Beijing (CN); Ligang LI, Beijing (CN); Kaixiang HUANG, Beijing (CN)

(21) Appl. No.: 19/040,065

(22) Filed: Jan. 29, 2025

(30) Foreign Application Priority Data
Jan. 29, 2024 (CN) 202410124010.X

(51) Int. Cl. G06T 15/40; G06F 3/01; G06T 7/11; G06T 7/246; G06T 7/73; G06T 17/20; G06T 19/00

(52) U.S. Cl. CPC G06T 15/40; G06F 3/017; G06T 7/11; G06T 7/251; G06T 7/74; G06T 17/20; G06T 19/006; G06T 2207/20084; G06T 2207/20132; G06T 2207/30196; G06T 2207/30241; G06T 2210/22

(57) ABSTRACT

The embodiments of the present disclosure provide an image display method, an image display apparatus, a storage medium, and an electronic device. The method includes: determining, in response to receiving a realistic scene image including a hand object, whether the hand object overlaps with a virtual screen at a preset spatial position; selecting target mesh information corresponding to the hand object from three-dimensional mesh information corresponding to the realistic scene image when the hand object overlaps with the virtual screen; cropping a target image corresponding to the hand object from the realistic scene image, and combining the target image with the target mesh information to obtain a three-dimensional hand image corresponding to the hand object; and displaying the virtual screen and the three-dimensional hand image on a display interface of a head-mounted device, based on the preset spatial position and the three-dimensional hand image.

### CROSS-REFERENCE TO RELATED APPLICATION

This application claims the priority to and benefits of the Chinese Patent Application No. 202410124010.X, filed on Jan. 29, 2024, the entire disclosure of which is incorporated herein by reference as part of the disclosure of this application.

### TECHNICAL FIELD

Embodiments of the present disclosure relate to the technical field of head-mounted devices, and in particular, to an image display method, an image display apparatus, an electronic device, and a storage medium.

### BACKGROUND

With the development of technology of head-mounted devices, in order to improve the display authenticity of head-mounted devices by incorporating elements of a realistic scene, the head-mounted devices can display an image that combines the realistic scene and a virtual object. The virtual object may be a two-dimensional virtual object, for example, a virtual display screen. The virtual object may also be a three-dimensional virtual object, for example, a virtual airplane model, a virtual cartoon character, etc.

Usually, when an image that combines a realistic scene and a virtual object is displayed, the virtual object is generally superimposed in front of the realistic scene, such that the realistic scene does not occlude the virtual object, thereby ensuring complete display of the virtual object.

However, there may be at least the following technical problems. When the realistic scene includes a user's hand, the virtual object may occlude the user's hand (e.g., the virtual display screen may occlude the user's hand), causing the user to be unable to perceive the hand position, thus resulting in a poor image display effect.

### SUMMARY

The embodiments of the present disclosure provide an image display method, an image display apparatus, an electronic device, and a storage medium, which can improve the image display effect.

According to a first aspect, an embodiment of the present disclosure provides an image display method applied to a head-mounted device on which a camera module is provided, and the method includes:
determining, in response to receiving a realistic scene image which is acquired by the camera module and comprises a hand object, whether the hand object overlaps with a virtual screen at a preset spatial position;
selecting target mesh information corresponding to the hand object from three-dimensional mesh information corresponding to the realistic scene image when the hand object overlaps with the virtual screen, wherein the target mesh information is used to represent three-dimensional spatial information corresponding to the hand object;
cropping a target image corresponding to the hand object from the realistic scene image, and combining the target image with the target mesh information to obtain a three-dimensional hand image corresponding to the hand object; and
displaying the virtual screen and the three-dimensional hand image on a display interface of the head-mounted device, based on the preset spatial position corresponding to the virtual screen and the three-dimensional hand image corresponding to the hand object.

According to a second aspect, an embodiment of the present disclosure provides an image display apparatus applied to a head-mounted device on which a camera module is provided, and the apparatus includes:
a receiving module, configured to determine, in response to receiving a realistic scene image which is acquired by the camera module and comprises a hand object, whether the hand object overlaps with a virtual screen at a preset spatial position;
a selection module, configured to select target mesh information corresponding to the hand object from three-dimensional mesh information corresponding to the realistic scene image when the hand object overlaps with the virtual screen, wherein the target mesh information is used to represent three-dimensional spatial information corresponding to the hand object;
a cropping module, configured to crop a target image corresponding to the hand object from the realistic scene image, and combine the target image with the target mesh information to obtain a three-dimensional hand image corresponding to the hand object; and
a display module, configured to display the virtual screen and the three-dimensional hand image on a display interface of the head-mounted device, based on the preset spatial position corresponding to the virtual screen and the three-dimensional hand image corresponding to the hand object.

According to a third aspect, an embodiment of the present disclosure provides an electronic device, the electronic device includes a processor and a memory, the memory is in communication with the processor, the memory stores computer-executable instructions, and the computer-executable instructions, when executed by the processor, cause the processor to implement the image display method according to the first aspect.

According to a fourth aspect, an embodiment of the present disclosure provides a computer-readable storage medium, computer-executable instructions are stored on the computer-readable storage medium, and the computer-executable instructions, when executed by a processor, cause the processor to implement the image display method according to the first aspect.

According to a fifth aspect, an embodiment of the present disclosure provides a computer program product, the computer program product includes a computer program, and the computer program, when executed by a processor, causes the processor to implement the image display method according to the first aspect.

For the image display method, the image display apparatus, the electronic device, and the storage medium provided by the embodiments, the method includes: determining, in response to receiving a realistic scene image which is acquired by a camera module and comprises a hand object, whether the hand object overlaps with a virtual screen at a preset spatial position; selecting target mesh information corresponding to the hand object from three-dimensional mesh information corresponding to the realistic scene image when the hand object overlaps with the virtual screen, wherein the target mesh information is used to represent three-dimensional spatial information corresponding to the hand object; cropping a target image corresponding to the hand object from the realistic scene image, and combining the target image with the target mesh information to obtain a three-dimensional hand image corresponding to the hand object; and displaying the virtual screen and the three-dimensional hand image on a display interface of a head-mounted device, based on the preset spatial position corresponding to the virtual screen and the three-dimensional hand image corresponding to the hand object. In the embodiments of the present disclosure, the target image corresponding to the hand object is combined with the target mesh information corresponding to the hand object to obtain a three-dimensional hand image that can be separated from the realistic scene image, so that a correct occlusion relationship can be formed between the three-dimensional hand image and the virtual object, thereby improving the image display effect.

### BRIEF DESCRIPTION OF DRAWINGS

In order to more clearly illustrate the technical solutions of the embodiments of the present disclosure or technical solutions in the related art, the drawings that need to be used in description of the embodiments or related art will be briefly introduced in the following. It is obvious that the drawings described below are only related to some embodiments of the present disclosure, and for those skilled in the art, other drawings can be obtained based on these accompanying drawings without inventive efforts.

FIG. 1 is a schematic diagram of an application scenario of an image display method according to an embodiment of the present disclosure;

FIG. 2 is a flowchart of an image display method according to an embodiment of the present disclosure;

FIG. 3 is a flowchart of another image display method according to an embodiment of the present disclosure;

FIG. 4 is a block diagram of a structure of an image display apparatus according to an embodiment of the present disclosure; and

FIG. 5 is a schematic diagram of a hardware structure of an electronic device according to an embodiment of the present disclosure.

### DETAILED DESCRIPTION

In order to clarify the objectives, technical solutions, and advantages of the embodiments of the present disclosure, the technical solutions in the embodiments of the present disclosure will be clearly and completely described with reference to the accompanying drawings in the embodiments of the present disclosure. Obviously, the described embodiments are only a part of the embodiments of the present disclosure, not all of the embodiments. Based on the embodiments of the present disclosure, all other embodiments obtained by those skilled in the art without inventive efforts are within the protection scope of the present disclosure.

It should be noted that user information (including but not limited to user device information, user personal information, etc.) and data (including but not limited to data for analysis, stored data, displayed data, etc.) involved in the present disclosure are all information and data authorized by users or fully authorized by all parties, the collection, use and processing of relevant data require compliance with relevant laws and regulations as well as standards, and corresponding operation portals are provided for users to choose to authorize or reject.

In a virtual reality device, there are a large number of video see through (VST) images in a mixed reality (MR) characteristic-based scene. In the VST images, gesture interaction is a default mode of interaction. Moreover, the VST images are captured by a device and necessarily include a hand image of the user, and virtual reality interaction will superimpose a virtual display screen or a virtual object into the VST images. In this case, it is necessary to handle an occlusion relationship between the hand image of the user in the VST image and the real hand image.

Usually, when an image that combines a realistic scene and a virtual object is displayed, the virtual object is generally superimposed in front of the realistic scene, such that the realistic scene does not occlude the virtual object, thereby ensuring complete display of the virtual object. However, when the realistic scene includes a user's hand, the virtual object may occlude the user's hand (e.g., the virtual display screen may occlude the user's hand), causing the user to be unable to perceive the hand position, thus resulting in a poor image display effect.

Therefore, how to handle an occlusion relationship between a virtual object and a user's hand in order to improve the image display effect is a pressing issue to be solved.

In order to solve the above problems, the embodiments provide the following technical concepts. First, in response to receiving a realistic scene image that is acquired by a camera module and includes a hand object, it is determined whether the hand object overlaps with a virtual screen at a preset spatial position. Second, if the hand object overlaps with the virtual screen, target mesh information corresponding to the hand object is selected from three-dimensional mesh information corresponding to the realistic scene image, and the target mesh information is used to represent three-dimensional spatial information corresponding to the hand object. Then, a target image corresponding to the hand object is cropped from the realistic scene image, and the target image is combined with the target mesh information to obtain a three-dimensional hand image corresponding to the hand object. Finally, the virtual screen and the three-dimensional hand image are displayed on a display interface of a head-mounted device based on the preset spatial position corresponding to the virtual screen and the three-dimensional hand image corresponding to the hand object.

In the present disclosure, the target image corresponding to the hand object is combined with the target mesh information corresponding to the hand object to obtain a three-dimensional hand image that can be separated from the realistic scene image, such that a correct occlusion relationship can be formed between the three-dimensional hand image and the virtual object, thereby improving the image display effect.

An application scenario of the embodiments of the present disclosure is described below.

The image display method provided in the embodiments of the present disclosure can be applied to a display scenario for a virtual display screen and a hand object. FIG. 1 is a schematic diagram of an application scenario of an image display method according to an embodiment of the present disclosure. As shown in FIG. 1, the display image includes a realistic scene image 101, a virtual display screen 102, and a three-dimensional hand image 103. In the image display method, the three-dimensional hand image 103 of a hand object may be determined, and the three-dimensional hand image 103 may be separated from the realistic scene image 101, such that a correct occlusion relationship can be formed between the three-dimensional hand image 103 and the virtual display screen 102, thereby improving the image display effect. The image display method provided in the embodiments of the present disclosure is described in detail below with reference to specific embodiments.

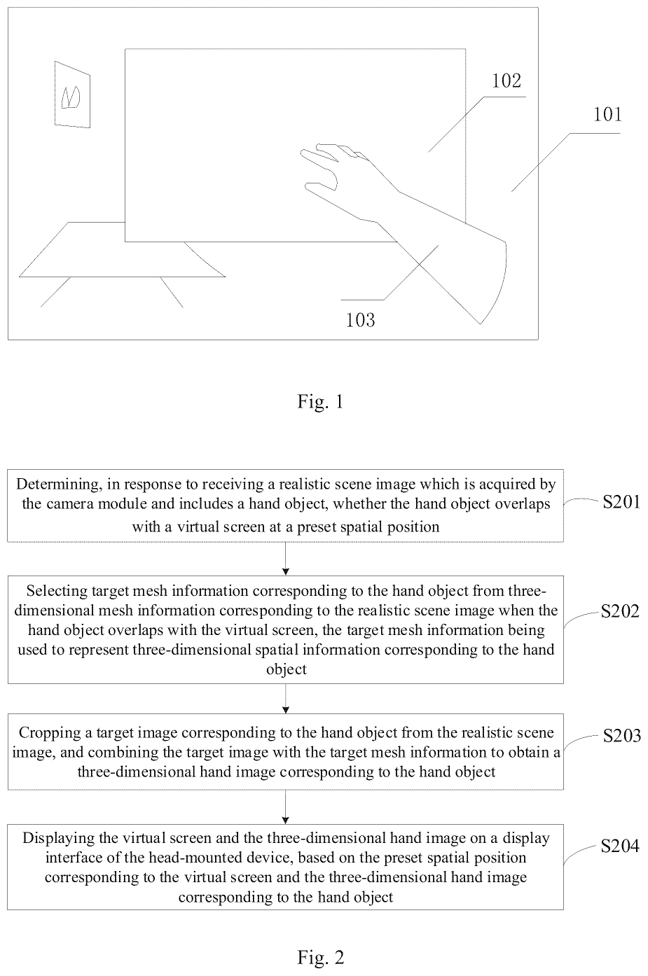

FIG. 2 is a flowchart of an image display method according to an embodiment of the present disclosure. The image display method can be applied to a head-mounted device on which a camera module is mounted. As shown in FIG. 2, the method includes the following steps.

S201: determining, in response to receiving a realistic scene image which is acquired by the camera module and includes a hand object, whether the hand object overlaps with a virtual screen at a preset spatial position.

In the embodiment of the present disclosure, the camera module may be a binocular camera, through which realistic scene images from two different perspectives can be obtained, such that three-dimensional information corresponding to the realistic scene image can be obtained through the two realistic scene images from different perspectives.

Optionally, the data acquired by the camera module is a video stream including a plurality of frames of realistic scene images. A three-dimensional image corresponding to a current frame of image is displayed on a display interface of the head-mounted device.

In the embodiment of the present disclosure, the virtual screen may be located at any preset spatial position on the display interface of the head-mounted device. The preset spatial position is used to define shape, size and depth information of the virtual screen.

In some embodiments, a coordinate region corresponding to the virtual screen may be pre-stored. Accordingly, determining whether the hand object overlaps with the virtual screen at the preset spatial position may include: obtaining three-dimensional coordinates of a plurality of vertices included in the hand object; if the three-dimensional coordinates of any vertex are located in a coordinate region corresponding to the virtual screen, determining that the hand object overlaps with the virtual screen at the preset spatial position; and if the three-dimensional coordinates of the plurality of vertices are not located in the coordinate region corresponding to the virtual screen, determining that the hand object does not overlap with the virtual screen at the preset spatial position.

S202: selecting target mesh information corresponding to the hand object from three-dimensional mesh information corresponding to the realistic scene image when the hand object overlaps with the virtual screen, the target mesh information being used to represent three-dimensional spatial information corresponding to the hand object.

In the embodiment of the present disclosure, the realistic scene image includes pixel regions respectively corresponding to a plurality of objects. Accordingly, selecting the target mesh information corresponding to the hand object from the three-dimensional mesh information corresponding to the realistic scene image includes: determining the three-dimensional mesh information corresponding to the realistic scene image, the three-dimensional mesh information including mesh information respectively corresponding to the plurality of pixel regions; and selecting, based on a target pixel region corresponding to the hand object, target mesh information corresponding to the target pixel region from the mesh information respectively corresponding to the plurality of pixel regions.

For example, the three-dimensional mesh information may be a mesh graph corresponding to the realistic scene image. The realistic scene image may include: a pixel region corresponding to a hand, a pixel region corresponding to a table, and a pixel region corresponding to a floor. A mesh graph corresponding to each pixel region may be pre-stored. For example, a hand mesh graph corresponding to the hand pixel region, a table mesh graph corresponding to the table pixel region, and a floor mesh graph corresponding to the floor pixel region may be pre-stored.

Optionally, determining the three-dimensional mesh information corresponding to the realistic scene image includes: extracting, for a pixel region corresponding to each object, a plurality of target pixels from the pixel region according to a preset sampling percentage; determining three-dimensional mesh vertices respectively corresponding to the plurality of target pixels, and constructing a plurality of adjacent and non-overlapping triangular patches through the three-dimensional mesh vertices respectively corresponding to the plurality of target pixels to obtain mesh information for the pixel region corresponding to the object; and combining the mesh information for the pixel regions respectively corresponding to the plurality of objects, to obtain the three-dimensional mesh information corresponding to the realistic scene image.

In the embodiment of the present disclosure, the value of the preset sampling percentage is not specifically limited, and may be set and modified as desired. For example, if the preset sampling percentage is 1:10, one target pixel is extracted for every 10 pixels, and the target pixel is determined as a three-dimensional mesh vertex. It should be noted that a larger preset sampling percentage indicates a greater number of sampling points, and a higher accuracy of the corresponding mesh information, but more data needs to be collected. On the contrary, a smaller preset sampling percentage indicates a smaller number of sampling points, and a lower accuracy of the corresponding mesh information, but less data needs to be collected.

Optionally, in order to improve the accuracy of the mesh information corresponding to the hand object, the sampling percentage may be increased for the hand object. Accordingly, extracting, for the pixel region corresponding to each object, the plurality of target pixels from the pixel region according to the preset sampling percentage includes: for a pixel region corresponding to each object, extracting a plurality of target pixels from the pixel region according to a first preset sampling percentage if the object is the hand object, and extracting a plurality of target pixels from the pixel region according to a second preset sampling percentage if the object is not the hand object. The first preset sampling percentage is greater than the second preset sampling percentage.

In the embodiment of the present disclosure, the values of the first preset sampling percentage and the second preset sampling percentage are not specifically limited, and may be set and modified as desired.

S203: cropping a target image corresponding to the hand object from the realistic scene image, and combining the target image with the target mesh information to obtain a three-dimensional hand image corresponding to the hand object.

In the embodiment of the present disclosure, an artificial intelligence (AI) model may be used to crop the hand object from the realistic scene image for recognition and extraction. Accordingly, cropping the target image corresponding to the hand object from the realistic scene image includes: recognizing the hand object in the realistic scene image through an artificial neural network model, to obtain a recognition result corresponding to the hand object; and cropping the target image corresponding to the hand object from the realistic scene image based on the recognition result corresponding to the hand object.

In some embodiments, in order to improve the accuracy of the cropped target image corresponding to the hand object, a small hand region may be first marked out, and then the target image corresponding to the hand object may be cropped from the hand region. Accordingly, cropping the target image corresponding to the hand object from the realistic scene image includes: selecting, from the realistic scene image, a local scene image including the hand object, and cropping the target image corresponding to the hand object from the local scene image. The display scale of the local scene image is greater than the display scale of the realistic scene image.

S204: displaying the virtual screen and the three-dimensional hand image on a display interface of the head-mounted device, based on the preset spatial position corresponding to the virtual screen and the three-dimensional hand image corresponding to the hand object.

In the embodiment of the present disclosure, the three-dimensional hand image and the virtual screen may be rendered based on the occlusion relationship between the virtual screen and the three-dimensional hand image. Accordingly, this step includes: determining an occlusion relationship between the virtual screen and the three-dimensional hand image, based on the preset spatial position corresponding to the virtual screen and the three-dimensional hand image corresponding to the hand object; and rendering, based on the occlusion relationship between the virtual screen and the three-dimensional hand image, the virtual screen and the three-dimensional hand image to obtain a composite image, and displaying the composite image on the display interface of the head-mounted device.

Optionally, the three-dimensional hand image includes three-dimensional coordinates of a plurality of first vertices corresponding to the hand object, and the preset spatial position includes three-dimensional coordinates of a plurality of second vertices corresponding to the virtual screen. In this case, the occlusion relationship between the virtual screen and the three-dimensional hand image may be determined through depth information in the three-dimensional coordinates. Accordingly, determining the occlusion relationship between the virtual screen and the three-dimensional hand image based on the preset spatial position corresponding to the virtual screen and the three-dimensional hand image corresponding to the hand object includes: for each first vertex of the first vertices in the three-dimensional hand image, selecting a target vertex with the same position as the first vertex in the three-dimensional hand image from the second vertices corresponding to the virtual screen. The same position indicates that the coordinate values in an X-axis direction are identical, and the coordinate values in a Y-axis direction are identical. When a coordinate value of the first vertex in a Z-axis direction is less than a coordinate value of the target vertex in the Z-axis direction, the first vertex in the three-dimensional hand image is occluded by the virtual screen; and when the coordinate value of the first vertex in the Z-axis direction is greater than the coordinate value of the target vertex in the Z-axis direction, the virtual screen is occluded by the first vertex in the three-dimensional hand image.

In some embodiments, if the first vertex in the three-dimensional hand image is occluded by the virtual screen, the first vertex has a lower rendering priority than that of the virtual screen, and in this case, the first vertex will be occluded by the virtual screen in the obtained composite image.

In some other embodiments, if the virtual screen is occluded by the first vertex in the three-dimensional hand image, the first vertex has a higher rendering priority than that of the virtual screen, and in this case, the virtual screen will be occluded by the first vertex in the obtained composite image.

An embodiment of the present disclosure provides an image display method. The method includes: in response to receiving a realistic scene image that is acquired by a camera module and includes a hand object, determining whether the hand object overlaps with a virtual screen at a preset spatial position; if the hand object overlaps with the virtual screen, selecting target mesh information corresponding to the hand object from three-dimensional mesh information corresponding to the realistic scene image, the target mesh information being used to represent three-dimensional spatial information corresponding to the hand object; cropping a target image corresponding to the hand object from the realistic scene image, and combining the target image with the target mesh information to obtain a three-dimensional hand image corresponding to the hand object; and displaying the virtual screen and the three-dimensional hand image on a display interface of a head-mounted device based on the preset spatial position overlapped with the virtual screen and the three-dimensional spatial information corresponding to the hand object. In the embodiments of the present disclosure, the target image corresponding to the hand object is combined with the target mesh information corresponding to the hand object to obtain a three-dimensional hand image that can be separated from the realistic scene image, such that a correct occlusion relationship can be formed between the three-dimensional hand image and the virtual screen, thereby improving the image display effect.

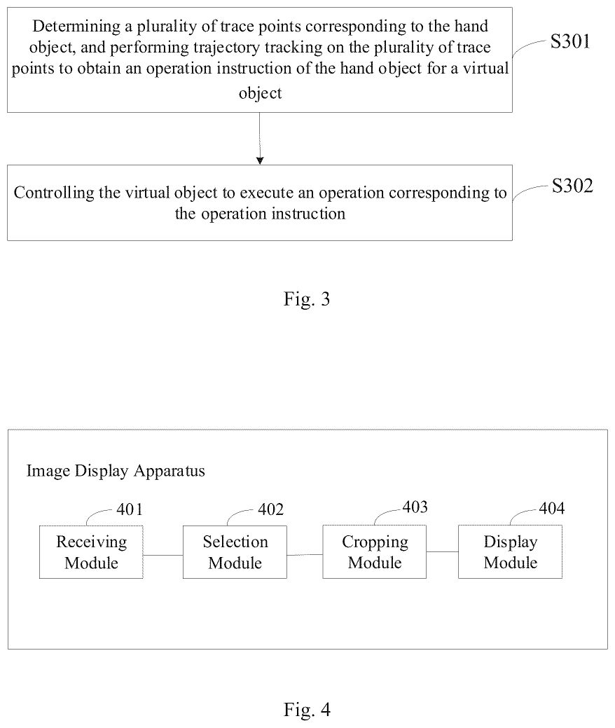

It should be noted that, according to the present disclosure, the hand object can be tracked, so as to implement an interaction operation with the virtual object. Accordingly, as shown in FIG. 3, the method includes the following steps.

S301: determining a plurality of trace points corresponding to the hand object, and performing trajectory tracking on the plurality of trace points to obtain an operation instruction of the hand object for a virtual object.

Optionally, different movement gestures of the hand object correspond to different operation instructions. Operation instructions respectively corresponding to a plurality of movement gestures may be pre-stored.

Accordingly, performing trajectory tracking on the plurality of trace points to obtain the operation instruction of the hand object for the virtual object includes: performing trajectory tracking on the plurality of trace points to obtain position information respectively corresponding to the plurality of trace points within a preset duration, the position information including first position information of the trace points before movement of the trace points, and second position information of the trace points after movement of the trace points; obtaining a movement gesture of the hand object based on the position information respectively corresponding to the plurality of trace points; and determining an operation instruction corresponding to the movement gesture as the operation instruction of the hand object for the virtual object.

In the embodiments of the present disclosure, the value of the preset duration is not specifically limited, and may be set and modified as desired. For example, the preset duration may be 1 second, 5 seconds, 10 seconds, etc.

S302: controlling the virtual object to execute an operation corresponding to the operation instruction.

For example, the controlled virtual object is a virtual display screen, and the operation instruction is a zoom-in operation for the virtual display screen. Accordingly, this step includes: zooming in the virtual display screen.

It should be noted that, in order to increase the fusion degree between the three-dimensional hand image and the virtual screen to improve the display effect of the composite image, some regions of the three-dimensional hand image may be feathered or made transparent.

In some embodiments, an edge region of the three-dimensional hand image is performed with feathering processing, and a distance between the edge region and an edge of the three-dimensional hand image is less than a first preset distance.

In this embodiment, the value of the first preset distance is not specifically limited, and may be set and modified as desired. For example, the first preset distance may be 0.5 cm. Optionally, a ratio of the first preset distance to the width of the three-dimensional hand image is a preset ratio. In this embodiment, the value of the preset ratio is not specifically limited, and may be set and modified as desired. For example, the ratio of the first preset distance to the width of the three-dimensional hand image is 1/10.

Here, the edge region of the three-dimensional hand image is feathered to increase the fusion degree between the three-dimensional hand image and the virtual screen, thereby improving the display effect of the composite image.

In some other embodiments, the three-dimensional hand image includes a hand and an arm, a target arm region of the arm is made transparent, and a distance between the target arm region and the hand is greater than a second preset distance.

In this embodiment, the value of the second preset distance is not specifically limited, and may be set and modified as desired. Optionally, the second preset distance may be the length of the forearm, in which case the upper arm may be made transparent.

Here, the target arm region of the arm is made transparent, and the target arm region is far away from the hand. In this case, applying transparency processing can avoid interference of the target arm region, and further increase the fusion degree between the three-dimensional hand image and the virtual screen, thereby improving the display effect of the composite image.

FIG. 4 is a block diagram of a structure of an image display apparatus according to an embodiment of the present disclosure. The image display apparatus is applied to a head-mounted device on which a camera module is provided. As illustrated in FIG. 4, the apparatus includes: a receiving module 401, a selection module 402, a cropping module 403, and a display module 404.

The receiving module 401 is configured to determine, in response to receiving a realistic scene image which is acquired by the camera module and comprises a hand object, whether the hand object overlaps with a virtual screen at a preset spatial position.

The selection module 402 is configured to select target mesh information corresponding to the hand object from three-dimensional mesh information corresponding to the realistic scene image when the hand object overlaps with the virtual screen, wherein the target mesh information is used to represent three-dimensional spatial information corresponding to the hand object.

The cropping module 403 is configured to crop a target image corresponding to the hand object from the realistic scene image, and combine the target image with the target mesh information to obtain a three-dimensional hand image corresponding to the hand object.

The display module 404 is configured to display the virtual screen and the three-dimensional hand image on a display interface of the head-mounted device, based on the preset spatial position corresponding to the virtual screen and the three-dimensional hand image corresponding to the hand object.

According to one or more embodiments of the present disclosure, the display module 404 is configured to determine an occlusion relationship between the virtual screen and the three-dimensional hand image, based on the preset spatial position corresponding to the virtual screen and the three-dimensional hand image corresponding to the hand object; and render, based on the occlusion relationship between the virtual screen and the three-dimensional hand image, the virtual screen and the three-dimensional hand image to obtain a composite image, and display the composite image on the display interface of the head-mounted device.

According to one or more embodiments of the present disclosure, the three-dimensional hand image comprises three-dimensional coordinates of a plurality of first vertices corresponding to the hand object, and the preset spatial position comprises three-dimensional coordinates of a plurality of second vertices corresponding to the virtual screen. The display module 404 is configured to, for each first vertex of the first vertices in the three-dimensional hand image, select a target vertex with an identical position as the first vertex in the three-dimensional hand image from the second vertices corresponding to the virtual screen. The identical position indicates identical coordinate values in an X-axis direction and identical coordinate values in a Y-axis direction. When a coordinate value of the first vertex in a Z-axis direction is less than a coordinate value of the target vertex in the Z-axis direction, the first vertex in the three-dimensional hand image is occluded by the virtual screen; and when the coordinate value of the first vertex in the Z-axis direction is greater than the coordinate value of the target vertex in the Z-axis direction, the virtual screen is occluded by the first vertex in the three-dimensional hand image.

According to one or more embodiments of the present disclosure, the realistic scene image comprises pixel regions respectively corresponding to a plurality of objects. Accordingly, the selection module 402 is configured to determine the three-dimensional mesh information corresponding to the realistic scene image, the three-dimensional mesh information including mesh information respectively corresponding to the plurality of pixel regions; and select, based on a target pixel region corresponding to the hand object, target mesh information corresponding to the target pixel region from the mesh information respectively corresponding to the plurality of pixel regions.

According to one or more embodiments of the present disclosure, the selection module 402 is configured to extract, for a pixel region corresponding to each object, a plurality of target pixels from the pixel region according to a preset sampling percentage; determine three-dimensional mesh vertices respectively corresponding to the plurality of target pixels, and construct a plurality of adjacent and non-overlapping triangular patches through the three-dimensional mesh vertices respectively corresponding to the plurality of target pixels to obtain mesh information for the pixel region corresponding to the object; and combine the mesh information for the pixel regions respectively corresponding to the plurality of objects, to obtain the three-dimensional mesh information corresponding to the realistic scene image.

According to one or more embodiments of the present disclosure, the selection module 402 is configured to, for a pixel region corresponding to each object, extract a plurality of target pixels from the pixel region according to a first preset sampling percentage when the object is the hand object, and extract a plurality of target pixels from the pixel region according to a second preset sampling percentage when the object is not the hand object. The first preset sampling percentage is greater than the second preset sampling percentage.

According to one or more embodiments of the present disclosure, the cropping module 403 is configured to recognize the hand object in the realistic scene image through an artificial neural network model, to obtain a recognition result corresponding to the hand object; and crop the target image corresponding to the hand object from the realistic scene image based on the recognition result corresponding to the hand object.

According to one or more embodiments of the present disclosure, the cropping module 403 is configured to select, from the realistic scene image, a local scene image comprising the hand object, and crop the target image corresponding to the hand object from the local scene image. A display scale of the local scene image is greater than a display scale of the realistic scene image.

According to one or more embodiments of the present disclosure, the apparatus further includes an operation module, and the operation module is configured to: determine a plurality of trace points corresponding to the hand object, and perform trajectory tracking on the plurality of trace points to obtain an operation instruction of the hand object for a virtual object; and control the virtual object to execute an operation corresponding to the operation instruction.

According to one or more embodiments of the present disclosure, the operation module is configured to perform trajectory tracking on the plurality of trace points to obtain position information respectively corresponding to the plurality of trace points within a preset duration, the position information including first position information of the trace points before movement of the trace points and second position information of the trace points after movement of the trace points; obtain a movement gesture of the hand object based on the position information respectively corresponding to the plurality of trace points; and determine an operation instruction corresponding to the movement gesture as the operation instruction of the hand object for the virtual object.

According to one or more embodiments of the present disclosure, the apparatus further includes a processing module, and the processing module is configured to: perform feathering processing on an edge region of the three-dimensional hand image, where a distance between the edge region and an edge of the three-dimensional hand image is less than a first preset distance; and/or in case of the three-dimensional hand image comprising a hand and an arm, perform transparency processing on a target arm region of the arm, where a distance between the target arm region and the hand is greater than a second preset distance.

The receiving module 401, the selection module 402, the cropping module 403, and the display module 404 are connected sequentially. The image display apparatus provided by the embodiments of the present disclosure can execute the technical solutions of the above-mentioned method embodiments, and has similar implementation principle and technical effects, and details are not repeated here again in this embodiment.

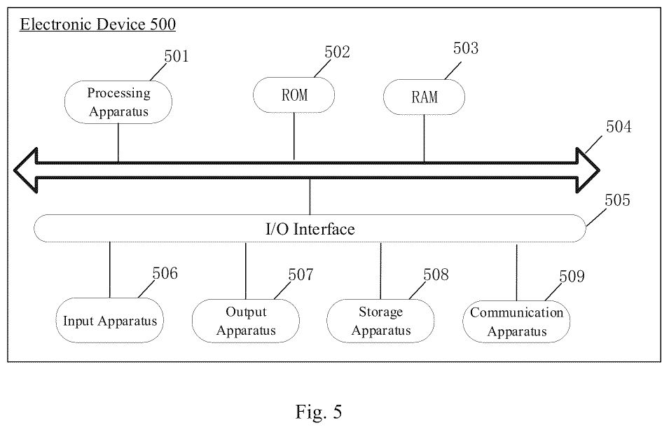

FIG. 5 is a schematic diagram of a hardware structure of an electronic device according to an embodiment of the present disclosure. Referring to FIG. 5, the electronic device 500 may be a terminal device or a server. The terminal device may include, but not limited to, mobile terminals, such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal), etc., and fixed terminals, such as a digital television (TV), a desktop computer, etc. The electronic device shown in FIG. 5 is merely an example and should not impose any limitations on the functions and scope of use of the embodiments of the present disclosure.

As illustrated in FIG. 5, the electronic device 500 may include a processing apparatus 501 (e.g., a central processing unit, a graphics processing unit, etc.), which may execute various appropriate actions and processing according to a program stored on a read-only memory (ROM) 502 or a program loaded from a storage apparatus 508 into a random access memory (RAM) 503. The RAM 503 further stores various programs and data required for operation of the electronic device 500. The processing apparatus 501, the ROM 502, and the RAM 503 are connected with each other through a bus 504. An input/output (I/O) interface 505 is also connected to the bus 504.

Usually, apparatuses below may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a speaker, a vibrator, or the like; a storage apparatus 508 including, for example, a magnetic tape, a hard disk, or the like; and a communication apparatus 509. The communication apparatus 509 may allow the electronic device 500 to perform wireless or wired communication with other devices so as to exchange data. Although FIG. 5 shows the electronic device 500 having various apparatuses, it should be understood that it is not required to implement or have all the apparatuses illustrated, and the electronic device may alternatively implement or have more or fewer apparatuses.

Specifically, according to the embodiments of the present disclosure, the process described above with reference to the flowchart may be implemented as a computer software program. For example, the embodiments of the present disclosure include a computer program product, including a computer program carried on a computer-readable medium, and the computer program includes program codes for executing the method shown in the flowchart. In such embodiments, the computer program may be downloaded and installed from the network via the communication apparatus 509, or installed from the storage apparatus 508, or installed from the ROM 502. When executed by the processing apparatus 501, the computer program may implement the above functions defined in the method provided by the embodiments of the present disclosure.

It should be noted that the computer-readable medium described in the present disclosure may be a computer-readable signal medium or a computer-readable storage medium, or any combination thereof. The computer-readable storage medium may be, but not limited to, an electric, magnetic, optical, electromagnetic, infrared, or semiconductor system, apparatus or device, or any combination thereof. For example, the computer-readable storage medium may include, but not limited to, an electrical connection with one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to, an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to, an electric wire, a fiber-optic cable, radio frequency (RF) and the like, or any appropriate combination of them.

The above-described computer-readable medium may be included in the above-described electronic device, or may also exist alone without being assembled into the electronic device.

The above-mentioned computer-readable medium carries one or more programs, and the one or more programs, when executed by the electronic device, cause the electronic device to implement the method provided in the embodiments described above.

The computer program codes for performing the operations of the present disclosure may be written in one or more programming languages or a combination thereof. The above-described programming languages include but are not limited to object-oriented programming languages, such as Java, Smalltalk, C++, and also include conventional procedural programming languages, such as the “C” programming language or similar programming languages. The program codes may by executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flow chart and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules and units involved in the embodiments of the present disclosure may be implemented in software or hardware. Here the name of the module or unit does not constitute a limitation of the module or unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), application specific standard parts (ASSP), a system on chip (SOC), a complex programmable logical device (CPLD), etc.

In the context of the present disclosure, the machine-readable medium may be a tangible medium containing or storing a program that can be used by or in combination with an instruction execution system, apparatus or device. The machine-readable medium may be a machine-readable signal medium or a machine-readable storage medium. The machine-readable medium may include, but not limited to, an electric, magnetic, optical, electromagnetic, infrared, or semiconductor system, apparatus or device, or any appropriate combination thereof. Examples of the machine-readable storage medium may include: an electrical connection based on one or more wires, a portable computer disk, a hard disk, a random access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them.

According to a first aspect, one or more embodiments of the present disclosure provide an image display method applied to a head-mounted device on which a camera module is provided, and the method includes:
determining, in response to receiving a realistic scene image which is acquired by the camera module and comprises a hand object, whether the hand object overlaps with a virtual screen at a preset spatial position;
selecting target mesh information corresponding to the hand object from three-dimensional mesh information corresponding to the realistic scene image when the hand object overlaps with the virtual screen, wherein the target mesh information is used to represent three-dimensional spatial information corresponding to the hand object;
cropping a target image corresponding to the hand object from the realistic scene image, and combining the target image with the target mesh information to obtain a three-dimensional hand image corresponding to the hand object; and
displaying the virtual screen and the three-dimensional hand image on a display interface of the head-mounted device, based on the preset spatial position corresponding to the virtual screen and the three-dimensional hand image corresponding to the hand object.

According to one or more embodiments of the present disclosure, displaying the virtual screen and the three-dimensional hand image on the display interface of the head-mounted device based on the preset spatial position corresponding to the virtual screen and the three-dimensional hand image corresponding to the hand object comprises: determining an occlusion relationship between the virtual screen and the three-dimensional hand image, based on the preset spatial position corresponding to the virtual screen and the three-dimensional hand image corresponding to the hand object; and rendering, based on the occlusion relationship between the virtual screen and the three-dimensional hand image, the virtual screen and the three-dimensional hand image to obtain a composite image, and displaying the composite image on the display interface of the head-mounted device.

According to one or more embodiments of the present disclosure, the three-dimensional hand image comprises three-dimensional coordinates of a plurality of first vertices corresponding to the hand object, and the preset spatial position comprises three-dimensional coordinates of a plurality of second vertices corresponding to the virtual screen; and determining the occlusion relationship between the virtual screen and the three-dimensional hand image based on the preset spatial position corresponding to the virtual screen and the three-dimensional hand image corresponding to the hand object comprises: for each first vertex of the first vertices in the three-dimensional hand image, selecting a target vertex with an identical position as the first vertex in the three-dimensional hand image from the second vertices corresponding to the virtual screen, wherein the identical position indicates identical coordinate values in an X-axis direction and identical coordinate values in a Y-axis direction, wherein when a coordinate value of the first vertex in a Z-axis direction is less than a coordinate value of the target vertex in the Z-axis direction, the first vertex in the three-dimensional hand image is occluded by the virtual screen; and when the coordinate value of the first vertex in the Z-axis direction is greater than the coordinate value of the target vertex in the Z-axis direction, the virtual screen is occluded by the first vertex in the three-dimensional hand image.

According to one or more embodiments of the present disclosure, the realistic scene image comprises pixel regions respectively corresponding to a plurality of objects; and selecting the target mesh information corresponding to the hand object from the three-dimensional mesh information corresponding to the realistic scene image comprises: determining the three-dimensional mesh information corresponding to the realistic scene image, wherein the three-dimensional mesh information comprises mesh information respectively corresponding to the plurality of pixel regions; and selecting, based on a target pixel region corresponding to the hand object, target mesh information corresponding to the target pixel region from the mesh information respectively corresponding to the plurality of pixel regions.

According to one or more embodiments of the present disclosure, determining the three-dimensional mesh information corresponding to the realistic scene image comprises: extracting, for a pixel region corresponding to each object, a plurality of target pixels from the pixel region according to a preset sampling percentage; determining three-dimensional mesh vertices respectively corresponding to the plurality of target pixels, and constructing a plurality of adjacent and non-overlapping triangular patches through the three-dimensional mesh vertices respectively corresponding to the plurality of target pixels to obtain mesh information for the pixel region corresponding to the object; and combining the mesh information for the pixel regions respectively corresponding to the plurality of objects, to obtain the three-dimensional mesh information corresponding to the realistic scene image.

According to one or more embodiments of the present disclosure, extracting, for the pixel region corresponding to each object, the plurality of target pixels from the pixel region according to the preset sampling percentage comprises: for a pixel region corresponding to each object, extracting a plurality of target pixels from the pixel region according to a first preset sampling percentage when the object is the hand object, and extracting a plurality of target pixels from the pixel region according to a second preset sampling percentage when the object is not the hand object, wherein the first preset sampling percentage is greater than the second preset sampling percentage.

According to one or more embodiments of the present disclosure, cropping the target image corresponding to the hand object from the realistic scene image comprises: recognizing the hand object in the realistic scene image through an artificial neural network model, to obtain a recognition result corresponding to the hand object; and cropping the target image corresponding to the hand object from the realistic scene image based on the recognition result corresponding to the hand object.

According to one or more embodiments of the present disclosure, cropping the target image corresponding to the hand object from the realistic scene image comprises: selecting, from the realistic scene image, a local scene image comprising the hand object, and cropping the target image corresponding to the hand object from the local scene image, wherein a display scale of the local scene image is greater than a display scale of the realistic scene image.

According to one or more embodiments of the present disclosure, the method further comprises: determining a plurality of trace points corresponding to the hand object, and performing trajectory tracking on the plurality of trace points to obtain an operation instruction of the hand object for a virtual object; and controlling the virtual object to execute an operation corresponding to the operation instruction.

According to one or more embodiments of the present disclosure, performing trajectory tracking on the plurality of trace points to obtain the operation instruction of the hand object for the virtual object comprises: performing trajectory tracking on the plurality of trace points to obtain position information respectively corresponding to the plurality of trace points within a preset duration, wherein the position information comprises first position information of the trace points before movement of the trace points, and second position information of the trace points after movement of the trace points; obtaining a movement gesture of the hand object based on the position information respectively corresponding to the plurality of trace points; and determining an operation instruction corresponding to the movement gesture as the operation instruction of the hand object for the virtual object.

According to one or more embodiments of the present disclosure, the method further comprises: performing feathering processing on an edge region of the three-dimensional hand image, wherein a distance between the edge region and an edge of the three-dimensional hand image is less than a first preset distance; and/or in case of the three-dimensional hand image comprising a hand and an arm, performing transparency processing on a target arm region of the arm, wherein a distance between the target arm region and the hand is greater than a second preset distance.

According to a second aspect, one or more embodiments of the present disclosure provide an image display apparatus applied to a head-mounted device on which a camera module is provided, and the apparatus includes:
a receiving module, configured to determine, in response to receiving a realistic scene image which is acquired by the camera module and comprises a hand object, whether the hand object overlaps with a virtual screen at a preset spatial position;
a selection module, configured to select target mesh information corresponding to the hand object from three-dimensional mesh information corresponding to the realistic scene image when the hand object overlaps with the virtual screen, wherein the target mesh information is used to represent three-dimensional spatial information corresponding to the hand object;
a cropping module, configured to crop a target image corresponding to the hand object from the realistic scene image, and combine the target image with the target mesh information to obtain a three-dimensional hand image corresponding to the hand object; and
a display module, configured to display the virtual screen and the three-dimensional hand image on a display interface of the head-mounted device, based on the preset spatial position corresponding to the virtual screen and the three-dimensional hand image corresponding to the hand object.

According to one or more embodiments of the present disclosure, the display module is configured to determine an occlusion relationship between the virtual screen and the three-dimensional hand image, based on the preset spatial position corresponding to the virtual screen and the three-dimensional hand image corresponding to the hand object; and render, based on the occlusion relationship between the virtual screen and the three-dimensional hand image, the virtual screen and the three-dimensional hand image to obtain a composite image, and display the composite image on the display interface of the head-mounted device.

According to one or more embodiments of the present disclosure, the three-dimensional hand image comprises three-dimensional coordinates of a plurality of first vertices corresponding to the hand object, and the preset spatial position comprises three-dimensional coordinates of a plurality of second vertices corresponding to the virtual screen. The display module is configured to, for each first vertex of the first vertices in the three-dimensional hand image, select a target vertex with an identical position as the first vertex in the three-dimensional hand image from the second vertices corresponding to the virtual screen. The identical position indicates identical coordinate values in an X-axis direction and identical coordinate values in a Y-axis direction. When a coordinate value of the first vertex in a Z-axis direction is less than a coordinate value of the target vertex in the Z-axis direction, the first vertex in the three-dimensional hand image is occluded by the virtual screen; and when the coordinate value of the first vertex in the Z-axis direction is greater than the coordinate value of the target vertex in the Z-axis direction, the virtual screen is occluded by the first vertex in the three-dimensional hand image.

According to one or more embodiments of the present disclosure, the realistic scene image comprises pixel regions respectively corresponding to a plurality of objects. Accordingly, the selection module is configured to determine the three-dimensional mesh information corresponding to the realistic scene image, the three-dimensional mesh information including mesh information respectively corresponding to the plurality of pixel regions; and select, based on a target pixel region corresponding to the hand object, target mesh information corresponding to the target pixel region from the mesh information respectively corresponding to the plurality of pixel regions.

According to one or more embodiments of the present disclosure, the selection module is configured to extract, for a pixel region corresponding to each object, a plurality of target pixels from the pixel region according to a preset sampling percentage; determine three-dimensional mesh vertices respectively corresponding to the plurality of target pixels, and construct a plurality of adjacent and non-overlapping triangular patches through the three-dimensional mesh vertices respectively corresponding to the plurality of target pixels to obtain mesh information for the pixel region corresponding to the object; and combine the mesh information for the pixel regions respectively corresponding to the plurality of objects, to obtain the three-dimensional mesh information corresponding to the realistic scene image.

According to one or more embodiments of the present disclosure, the selection module is configured to, for a pixel region corresponding to each object, extract a plurality of target pixels from the pixel region according to a first preset sampling percentage when the object is the hand object, and extract a plurality of target pixels from the pixel region according to a second preset sampling percentage when the object is not the hand object. The first preset sampling percentage is greater than the second preset sampling percentage.

According to one or more embodiments of the present disclosure, the cropping module is configured to recognize the hand object in the realistic scene image through an artificial neural network model, to obtain a recognition result corresponding to the hand object; and crop the target image corresponding to the hand object from the realistic scene image based on the recognition result corresponding to the hand object.

According to one or more embodiments of the present disclosure, the cropping module is configured to select, from the realistic scene image, a local scene image comprising the hand object, and crop the target image corresponding to the hand object from the local scene image. A display scale of the local scene image is greater than a display scale of the realistic scene image.

According to one or more embodiments of the present disclosure, the apparatus further includes an operation module, and the operation module is configured to: determine a plurality of trace points corresponding to the hand object, and perform trajectory tracking on the plurality of trace points to obtain an operation instruction of the hand object for a virtual object; and control the virtual object to execute an operation corresponding to the operation instruction.

According to one or more embodiments of the present disclosure, the operation module is configured to perform trajectory tracking on the plurality of trace points to obtain position information respectively corresponding to the plurality of trace points within a preset duration, the position information including first position information of the trace points before movement of the trace points and second position information of the trace points after movement of the trace points; obtain a movement gesture of the hand object based on the position information respectively corresponding to the plurality of trace points; and determine an operation instruction corresponding to the movement gesture as the operation instruction of the hand object for the virtual object.

According to one or more embodiments of the present disclosure, the apparatus further includes a processing module, and the processing module is configured to: perform feathering processing on an edge region of the three-dimensional hand image, where a distance between the edge region and an edge of the three-dimensional hand image is less than a first preset distance; and/or in case of the three-dimensional hand image comprising a hand and an arm, perform transparency processing on a target arm region of the arm, where a distance between the target arm region and the hand is greater than a second preset distance.

According to a third aspect, one or more embodiments of the present disclosure provide an electronic device, the electronic device includes a processor and a memory, the memory is in communication with the processor, the memory stores computer-executable instructions, and the computer-executable instructions, when executed by the processor, cause the processor to implement the image display method according to the first aspect and various possible designs of the first aspect.

According to a fourth aspect, one or more embodiments of the present disclosure provide a computer-readable storage medium, computer-executable instructions are stored on the computer-readable storage medium, and the computer-executable instructions, when executed by a processor, cause the processor to implement the image display method according to the first aspect and various possible designs of the first aspect.

According to a fifth aspect, at least one embodiment of the present disclosure provides a computer program product, the computer program product includes a computer program, and the computer program, when executed by a processor, causes the processor to implement the image display method according to the first aspect and various possible designs of the first aspect.

The foregoing are merely descriptions of the preferred embodiments of the present disclosure and the explanations of the technical principles involved. It should be understood by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method actions, it should be understood that the subject matter defined in the appended claims is not necessarily limited to the particular features and actions described above. Rather, the particular features and actions described above are merely exemplary forms for implementing the claims.

What is claimed is:

1. An image display method, applied to a head-mounted device on which a camera module is provided, wherein the method comprises:
determining, in response to receiving a realistic scene image which is acquired by the camera module and comprises a hand object, whether the hand object overlaps with a virtual screen at a preset spatial position;
selecting target mesh information corresponding to the hand object from three-dimensional mesh information corresponding to the realistic scene image when the hand object overlaps with the virtual screen, wherein the target mesh information is used to represent three-dimensional spatial information corresponding to the hand object;
cropping a target image corresponding to the hand object from the realistic scene image, and combining the target image with the target mesh information to obtain a three-dimensional hand image corresponding to the hand object; and
displaying the virtual screen and the three-dimensional hand image on a display interface of the head-mounted device, based on the preset spatial position corresponding to the virtual screen and the three-dimensional hand image corresponding to the hand object.

2. The method according to claim 1, wherein displaying the virtual screen and the three-dimensional hand image on the display interface of the head-mounted device based on the preset spatial position corresponding to the virtual screen and the three-dimensional hand image corresponding to the hand object comprises:
determining an occlusion relationship between the virtual screen and the three-dimensional hand image, based on the preset spatial position corresponding to the virtual screen and the three-dimensional hand image corresponding to the hand object; and
rendering, based on the occlusion relationship between the virtual screen and the three-dimensional hand image, the virtual screen and the three-dimensional hand image to obtain a composite image, and displaying the composite image on the display interface of the head-mounted device.

3. The method according to claim 2, wherein the three-dimensional hand image comprises three-dimensional coordinates of a plurality of first vertices corresponding to the hand object, and the preset spatial position comprises three-dimensional coordinates of a plurality of second vertices corresponding to the virtual screen; and
determining the occlusion relationship between the virtual screen and the three-dimensional hand image based on the preset spatial position corresponding to the virtual screen and the three-dimensional hand image corresponding to the hand object comprises:
for each first vertex of the first vertices in the three-dimensional hand image, selecting a target vertex with an identical position as the first vertex in the three-dimensional hand image from the second vertices corresponding to the virtual screen, wherein the identical position indicates identical coordinate values in an X-axis direction and identical coordinate values in a Y-axis direction,
wherein when a coordinate value of the first vertex in a Z-axis direction is less than a coordinate value of the target vertex in the Z-axis direction, the first vertex in the three-dimensional hand image is occluded by the virtual screen; and
when the coordinate value of the first vertex in the Z-axis direction is greater than the coordinate value of the target vertex in the Z-axis direction, the virtual screen is occluded by the first vertex in the three-dimensional hand image.

4. The method according to claim 1, wherein the realistic scene image comprises pixel regions respectively corresponding to a plurality of objects; and
selecting the target mesh information corresponding to the hand object from the three-dimensional mesh information corresponding to the realistic scene image comprises:
determining the three-dimensional mesh information corresponding to the realistic scene image, wherein the three-dimensional mesh information comprises mesh information respectively corresponding to the plurality of pixel regions; and
selecting, based on a target pixel region corresponding to the hand object, target mesh information corresponding to the target pixel region from the mesh information respectively corresponding to the plurality of pixel regions.

5. The method according to claim 4, wherein determining the three-dimensional mesh information corresponding to the realistic scene image comprises:
extracting, for a pixel region corresponding to each object, a plurality of target pixels from the pixel region according to a preset sampling percentage;
determining three-dimensional mesh vertices respectively corresponding to the plurality of target pixels, and constructing a plurality of adjacent and non-overlapping triangular patches through the three-dimensional mesh vertices respectively corresponding to the plurality of target pixels to obtain mesh information for the pixel region corresponding to the object; and
combining the mesh information for the pixel regions respectively corresponding to the plurality of objects, to obtain the three-dimensional mesh information corresponding to the realistic scene image.

6. The method according to claim 5, wherein extracting, for the pixel region corresponding to each object, the plurality of target pixels from the pixel region according to the preset sampling percentage comprises:
for a pixel region corresponding to each object, extracting a plurality of target pixels from the pixel region according to a first preset sampling percentage when the object is the hand object, and extracting a plurality of target pixels from the pixel region according to a second preset sampling percentage when the object is not the hand object,
wherein the first preset sampling percentage is greater than the second preset sampling percentage.

7. The method according to claim 1, wherein cropping the target image corresponding to the hand object from the realistic scene image comprises:
recognizing the hand object in the realistic scene image through an artificial neural network model, to obtain a recognition result corresponding to the hand object; and
cropping the target image corresponding to the hand object from the realistic scene image based on the recognition result corresponding to the hand object.

8. The method according to claim 7, wherein cropping the target image corresponding to the hand object from the realistic scene image comprises:
selecting, from the realistic scene image, a local scene image comprising the hand object, and cropping the target image corresponding to the hand object from the local scene image, wherein a display scale of the local scene image is greater than a display scale of the realistic scene image.

9. The method according to claim 1, further comprising:
determining a plurality of trace points corresponding to the hand object, and performing trajectory tracking on the plurality of trace points to obtain an operation instruction of the hand object for a virtual object; and
controlling the virtual object to execute an operation corresponding to the operation instruction.

10. The method according to claim 9, wherein performing trajectory tracking on the plurality of trace points to obtain the operation instruction of the hand object for the virtual object comprises:
performing trajectory tracking on the plurality of trace points to obtain position information respectively corresponding to the plurality of trace points within a preset duration, wherein the position information comprises first position information of the trace points before movement of the trace points, and second position information of the trace points after movement of the trace points;
obtaining a movement gesture of the hand object based on the position information respectively corresponding to the plurality of trace points; and
determining an operation instruction corresponding to the movement gesture as the operation instruction of the hand object for the virtual object.

11. The method according to claim 1, further comprising:
performing feathering processing on an edge region of the three-dimensional hand image, wherein a distance between the edge region and an edge of the three-dimensional hand image is less than a first preset distance; and/or
in case of the three-dimensional hand image comprising a hand and an arm, performing transparency processing on a target arm region of the arm, wherein a distance between the target arm region and the hand is greater than a second preset distance.

12. An image display apparatus, applied to a head-mounted device on which a camera module is provided, wherein the apparatus comprises:
a receiving module, configured to determine, in response to receiving a realistic scene image which is acquired by the camera module and comprises a hand object, whether the hand object overlaps with a virtual screen at a preset spatial position;
a selection module, configured to select target mesh information corresponding to the hand object from three-dimensional mesh information corresponding to the realistic scene image when the hand object overlaps with the virtual screen, wherein the target mesh information is used to represent three-dimensional spatial information corresponding to the hand object;
a cropping module, configured to crop a target image corresponding to the hand object from the realistic scene image, and combine the target image with the target mesh information to obtain a three-dimensional hand image corresponding to the hand object; and
a display module, configured to display the virtual screen and the three-dimensional hand image on a display interface of the head-mounted device, based on the preset spatial position corresponding to the virtual screen and the three-dimensional hand image corresponding to the hand object.

13. An electronic device, comprising a processor and a memory,
wherein the memory is in communication with the processor,
the memory stores computer-executable instructions, and
the computer-executable instructions, when executed by the processor, cause the processor to implement an image display method applied to a head-mounted device on which a camera module is provided, which comprises:
determining, in response to receiving a realistic scene image which is acquired by the camera module and comprises a hand object, whether the hand object overlaps with a virtual screen at a preset spatial position;
selecting target mesh information corresponding to the hand object from three-dimensional mesh information corresponding to the realistic scene image when the hand object overlaps with the virtual screen, wherein the target mesh information is used to represent three-dimensional spatial information corresponding to the hand object;
cropping a target image corresponding to the hand object from the realistic scene image, and combining the target image with the target mesh information to obtain a three-dimensional hand image corresponding to the hand object; and
displaying the virtual screen and the three-dimensional hand image on a display interface of the head-mounted device, based on the preset spatial position corresponding to the virtual screen and the three-dimensional hand image corresponding to the hand object.

14. A computer-readable storage medium, wherein computer-executable instructions are stored on the computer-readable storage medium, and the computer-executable instructions, when executed by a processor, cause the processor to implement the image display method according to claim 1.

15. A computer program product, comprising a computer program,
wherein the computer program, when executed by a processor, causes the processor to implement the image display method according to claim 1.
